(19) United States
(12) Patent Application Publication
(10) Pub. No.: US 2014/0252828 A1
(43) Pub. Date: Sep. 11, 2014

(54) CHILD SAFETY SEAT FOR MOTORCYCLES

(71) Applicant: WUN-CHUAN WANG, TAINAN CITY (TW)

(72) Inventor: WUN-CHUAN WANG, TAINAN CITY (TW)

(21) Appl. No.: 14/170,635

(22) Filed: Feb. 2, 2014

(30) Foreign Application Priority Data
Mar. 8, 2013 (TW) 102204382

(51) Int. Cl. B62J 1/16; B60N 2/28

(52) U.S. Cl. CPC B62J 1/162; B60N 2/2821
USPC 297/256.15; 297/256.16

(57) ABSTRACT

A motorcycle safety seat is disposed on a rear of a motorcycle. The motorcycle safety seat includes a safety seat, a fixing portion and a pivotal portion. The safety seat includes a seat portion and a joint portion. The joint portion is disposed under the seat portion and connected with the seat portion. The fixing portion is disposed fixedly on the rear of the motorcycle. The pivotal portion is hinged between the safety seat and the fixing portion. The safety seat detachably connects to the fixing portion by the joint portion, and the safety seat is raised by the pivotal portion being a rotation central shaft.

### BACKGROUND OF THE INVENTION

1. Field of the Invention

The present invention relates to a safety seat, more particular, to a motorcycle safety seat.

2. Description of Related Art

When a rider transports a baby by a motorcycle, the rider usually takes a harness for holding the baby on the back or the chest of the rider. However, the rider may press and seriously hurt the baby held on the back or the chest when the rider falls in an accident.

In addition, a present simple seat on the market can be placed on the platform of a motorcycle (such as scooter), and the simple seat can hold a baby. However, the baby cannot sit smoothly on the motorcycle because the body of the baby is smaller and weaker. Moreover, when the rider rides the motorcycle, the baby may easily fall from the motorcycle because the motorcycle wobbles and then be injured.

### SUMMARY OF THE INVENTION

The embodiment of the present invention relates to a safety seat, more particular, to a motorcycle safety seat.

The embodiment of the present invention discloses a motorcycle safety seat disposed on a rear of the motorcycle. The motorcycle safety seat includes a seat body, a fixing portion and a pivotal portion. The safety seat includes a seat portion and a joint portion. The joint portion is disposed under the seat portion and connected with the seat portion. The fixing portion is disposed fixedly on the rear of the motorcycle. The pivotal portion is hinged between the seat body and the fixing portion. The seat body detachably connects to the fixing portion by the joint portion, and the seat body is rotated relative to the rear around the pivotal portion.

In sum up, the motorcycle safety seat in the embodiment of the present invention which includes the seat body, the fixing portion and the pivotal portion. The fixing portion provides the fixity and the stability and fixes the motorcycle safety seat on the rear of the motorcycle. The pivotal portion is hinged between seat body and the fixing portion, thus the seat body may be raised an angle toward the rear of the motorcycle by pivotal portion. Thus, the seat cushion further does not block off by the seat body.

In order to further the understanding regarding the present invention, the following embodiments are provided along with illustrations to facilitate the disclosure of the present invention.

### BRIEF DESCRIPTION OF THE DRAWINGS

FIG. 1 shows a diagram of a motorcycle safety seat according to an embodiment of the present invention;

FIG. 2 shows a diagram of a motorcycle safety seat according to an embodiment of the present invention;

FIG. 3 shows a diagram of the motorcycle safety seat of FIG. 2 in using;

FIG. 4 shows a diagram when the motorcycle safety seat of FIG. 3 is raised;

FIG. 5 shows a diagram of a motorcycle safety seat according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

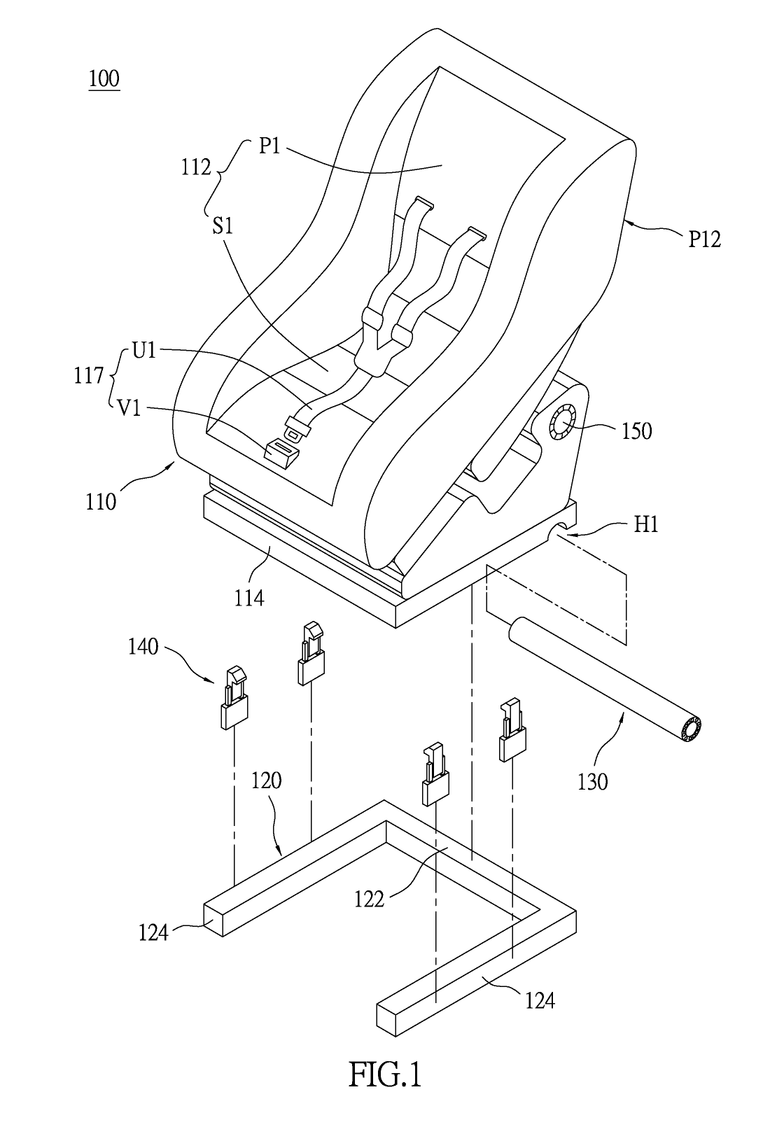

Please refer to FIG. 1, FIG. 1 shows a diagram of a motorcycle safety seat according to an embodiment of the present invention. A motorcycle safety seat includes a seat body 110, a fixing portion 120 and pivotal portion 130. The fixing portion 120 is fixed on a rear of a motorcycle, and the pivotal portion 130 is hinged between the fixing portion 120 and the bottom of the seat body 110. Thus, the seat body 110 may be rotated an angle with a cushion of the motorcycle around the pivotal portion 130.

The seat body 110 includes a seat portion 112 and a joint portion 114. More specifically, the joint portion 114 is disposed under the seat portion 112 and connected with the seat portion 112, and the seat portion 112 further includes a seat cushion 51 and a seat back-rest P1. The seat body 110 is configured for absorbing the tremor or the shake, and supplies the better frontal coverage and cushioning capability when the motorcycle is collided in riding. The seat cushion S1 and the seat back-rest P1 of the seat portion 112 are configured for placing the baby, and the joint portion 114 is configured for supplying the seat portion 112. In practice, the seat body 110 is formed integrally or designed by combination. In other word, the seat portion 112 and the joint portion 114 are formed integrally and connected fixedly, or the seat portion 112 and the joint portion 114 are connected by locking.

In addition, for increasing the security to the baby sat on the seat portion 112, the seat body 110 includes a safety belt 117. The safety belt 117 is disposed on the seat portion 112 and includes a strap U1 and a buckle V1, wherein the strap U1 and buckle V1 are connected with the seat back-rest P1 and the seat cushion S1 respectively. Furthermore, the safety belt 117 may be formed by a two-point form, a three-point form or a five-point form, wherein the safety belt 117 is formed the two-point just including a leg belt, the safety belt 117 is formed the three-point including a leg belt and a sash used simultaneously, and the safety belt 117 is formed the five-point including three belts, wherein two leg belts passed two armpits and another belt passed the two legs and the abdomen. However, the present disclosure isn't limited thereto.

The fixing portion 120 is disposed fixedly on the end of the motorcycle body. In practice, the fixing portion 120 is a frame disposed fixedly on the rear of the motorcycle. In the embodiment of the present disclosure, the fixing portion 120 includes a first rod portion 122 and two second rod portions 124, wherein two ends of the first rod portion 122 are connected two second rod portions 124 respectively. Based on the structure illustrated above, the fixing portion 120 forms a U-shape frame. It's worth noting, the first rod portion 122 and the second rod portions 124 are disposed around the end of the motorcycle body. More specifically, the first rod portion 122 is disposed on the rear of the motorcycle, and the second rod portions 124 are disposed separately on two sides of the rear of the motorcycle. Thus, the fixing portion 120 may be fixed steady on the rear of the motorcycle.

However, for fixing the fixing portion 120 on the rear of the motorcycle in other embodiments, the fixing portion 120 includes a plurality of the first rod portions 122 and a plurality of the second rod portions 124, and the first rod portions 122 and the second rod portions 124 may be disposed on the rear of the motorcycle by the different combination. For instance, the first rod portions 122 and the second rod portions 124 form a triangle frame, an arc frame, or a rectangle frame. Thus, the present disclosure isn't limited thereto.

The pivotal portion 130 pivots between the seat body 110 and the fixing portion 120. In detail, the seat body 110 detachably connects to the fixing portion 120 by the joint portion 114, and the seat body 110 is rotated around the pivotal portion 130. Thus, the seat body 110 is raised in a direction which is from a rear of the motorcycle to a front of the motorcycle. In the embodiment of the present disclosure, the pivotal portion 130 is a whirling steel shaft assembly. More specifically, the pivotal portion 130 is configured on the first rod portion 122, and the joint portion 114 has a C-shape slot formation H1, further the first rod portion 122 is disposed within the C-shape slot formation H1 of the joint portion 114 and rotating itself in the C-shape slot formation H1. That is, the seat body 110 is raised by the pivotal portion 130 liked a rotation central shaft and is raised in a direction which is from the rear of the motorcycle to the front of the motorcycle by the pivotal portion 130 liked the rotation central shaft. In other word, the seat body 110 is raised relative to the motorcycle. It's worth noting, the seat body 110 may be raised an angle toward to the rear of the motorcycle by pivotal portion 130. Thus, the seat cushion further can be raised and do not block off by the seat body 110. However, the present disclosure isn't limited the kinds of the pivotal portion 130.

The motorcycle safety seat 100 further includes a plurality of quick release mechanisms 140. More specifically, the quick release mechanisms 140 are disposed between the joint portion 114 and the fixing portion 120, and the quick release mechanisms 140 are configured for locking the seat body 110 and the fixing portion 120. When the motorcycle safety seat 100 is disposed on the rear of the motorcycle, for avoiding shake under the condition of the motorcycle traveling, the quick release mechanisms 140 supply the seat body 110 and fixing portion 120 connecting strongly. Accordingly, when the rider wants to put the seat body 110 on the fixing portion 120, can be quick and convenient to lock the seat body 110 and the fixing portion 120. As shown in FIG. 1, the motorcycle safety seat 100 includes at least two quick release mechanisms 140, wherein the joint portion 114 of the seat body 110 connects with the fixing portion 120 by the quick release mechanisms 140. In the embodiment, the quick release mechanisms 140 are spring buckles, and disposed around the joint portion 114 and the fixing portion 120.

The motorcycle safety seat 100 further includes an adjustable assembly 150 configured for adjusting an oblique angle of the seat portion 112. More specifically, the adjustable assembly 150 is disposed into joint portion 114, and configured for adjusting the oblique angle between the seat back-rest P1 and the seat cushion S1. The adjustable assembly 150 is a button, a dial, a rod, or etc. designed for adjusting the oblique angle. In addition, according to the product requirement of the motorcycle safety seat 100, the motorcycle safety seat 100 may be unnecessary any adjustable assembly 150. So that, as said above, the adjustable assembly 150 illustrated in FIG. 1 isn't limited thereto.

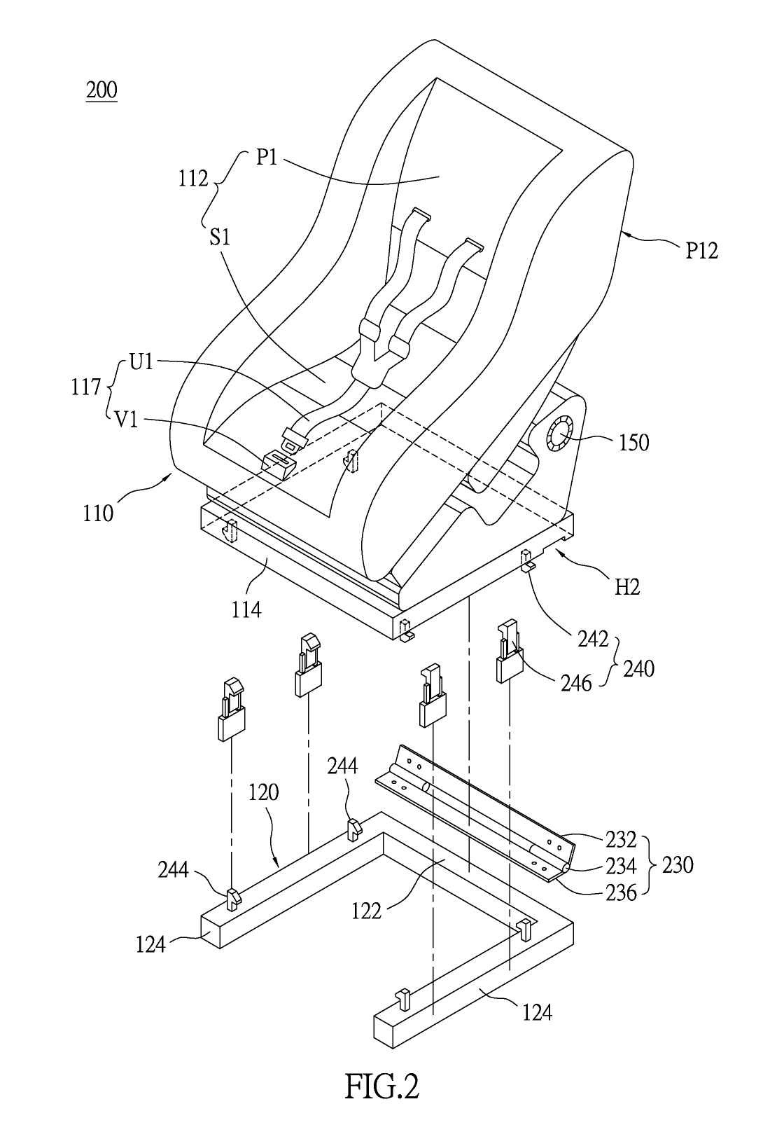

FIG. 2 shows a diagram of a motorcycle safety seat according to an embodiment of the present invention. Please refer to FIG. 2, a motorcycle safety seat 200 is similar to the motorcycle safety seat 100, such as the motorcycle safety seat 100 and 200 both have the seat body 110 and the fixing portion 120. Merely, there still has difference between the motorcycle safety seat 100 and 200. It further illustrates the difference between the motorcycle safety seat 100 and 200 as following, but other same features do not repeat here.

The motorcycle safety seat 200 of the embodiment includes the seat body 110, the fixing portion 120 and a pivotal portion 230. Please refer to FIG. 2, the pivotal portion 230 is a hinge. The hinge includes a first leaf 232, a second leaf 234 and a central shaft 236, wherein the first leaf 232 and second leaf 234 pivots with the central shaft 236 respectively. The first leaf 232 is disposed on the joint portion 114, and the second leaf 234 is disposed on the first rod portion 122. It's worth noting, the first leaf 234 is configured quickly and detachably on the slot H2 of the joint portion 114. Thus, similarly the seat body 110 may be raised and close to the rear of the motorcycle by the pivotal portion 230. Thus, the seat cushion further can be raised and do not block off by the seat body 110. However, the present disclosure isn't limited the kinds of the pivotal portion 230.

The quick release mechanism 240 include a plurality of tenons 242, a plurality of corresponding tenons 244, wherein the tenons 242, the corresponding tenons 244 are disposed around the side of the joint portion 114 and disposed on the second rod portions 124 of the fixing portion 120 respectively, and a plurality of spring buckles 246 are respectively disposed around the sides of two second rod portions 124. The rider may lock the tenons 242 with the corresponding tenons 244, and knit by the spring buckle 246. Thus, the joint portion 114 of the seat body 110 can be locked with the fixing portion 120 by the quick release mechanism 240. However, in other embodiment, the quick release mechanism 240 may be a snap buckle, a tenon or a spring buckle, other quick release mechanisms or any combination of the different quick release mechanisms. Thus, the present disclosure isn't limited thereto.

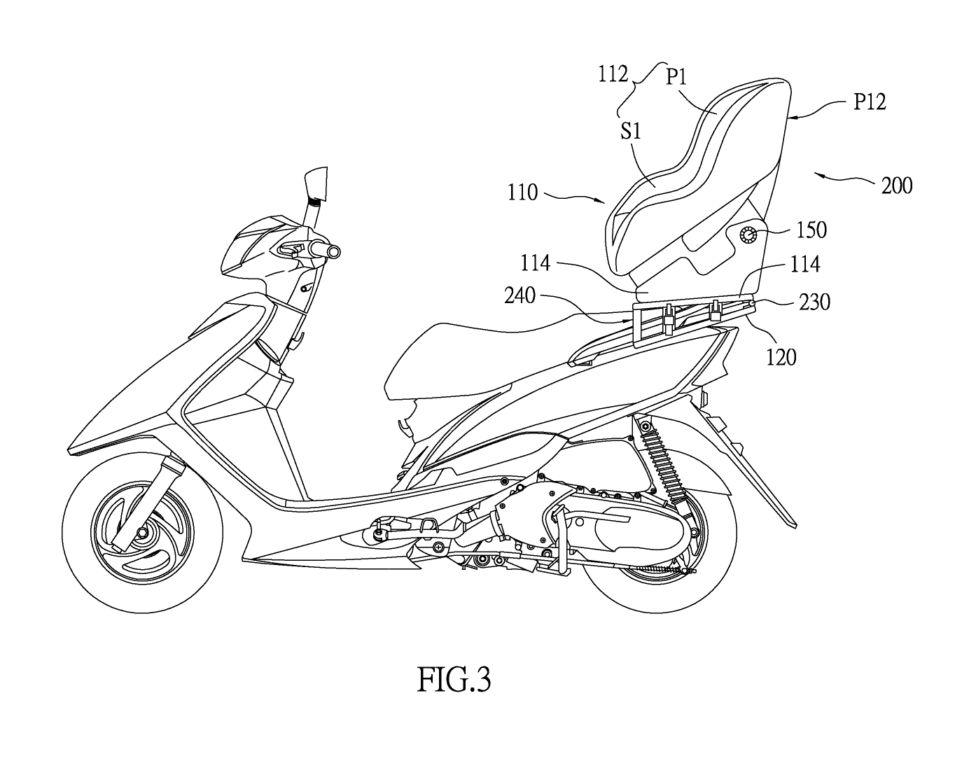

FIG. 3 shows a diagram of the motorcycle safety seat of FIG. 2 in using. In detail, when the rider disposes the motorcycle safety seat 200 on the rear of the motorcycle, firstly fixes the fixing portion 120 on the rear of the motorcycle. Then, the first rod portion 122 is fixed on the rear of the motorcycle, and two second rod portions 124 are fixed on the two opposite sides respectively of the rear of the motorcycle. Accordingly, the fixing portion 120 is steady disposed on the rear of the motorcycle.

After that, puts the seat body 110 on the seat cushion of the motorcycle rear. More specifically, through the pivotal portion 230, the angle between the seat body 110 and the fixing portion 120 is adjusted, and the seat body 110 disposed on the rear of the motorcycle can be configured on the seat cushion of the motorcycle rear.

Locks the seat body 110 and the fixing portion 120 by the quick release mechanisms 240. More specifically, each tenon 242 of the joint portion 114 matches and locks with each corresponding tenon 244. Then, locks the spring buckle 246 configured on the side of the joint portion 114 and the fixing portion 120. Thus, the seat body 110 steady fixes on the fixing portion 120. Thus, the rider may transport the baby by the motorcycle locating the motorcycle safety seat 200.

Finally, the rider places the baby into the inside of the seat portion 112, and fixes the baby by the belt, and the baby may sits steady on the safety seat 200.

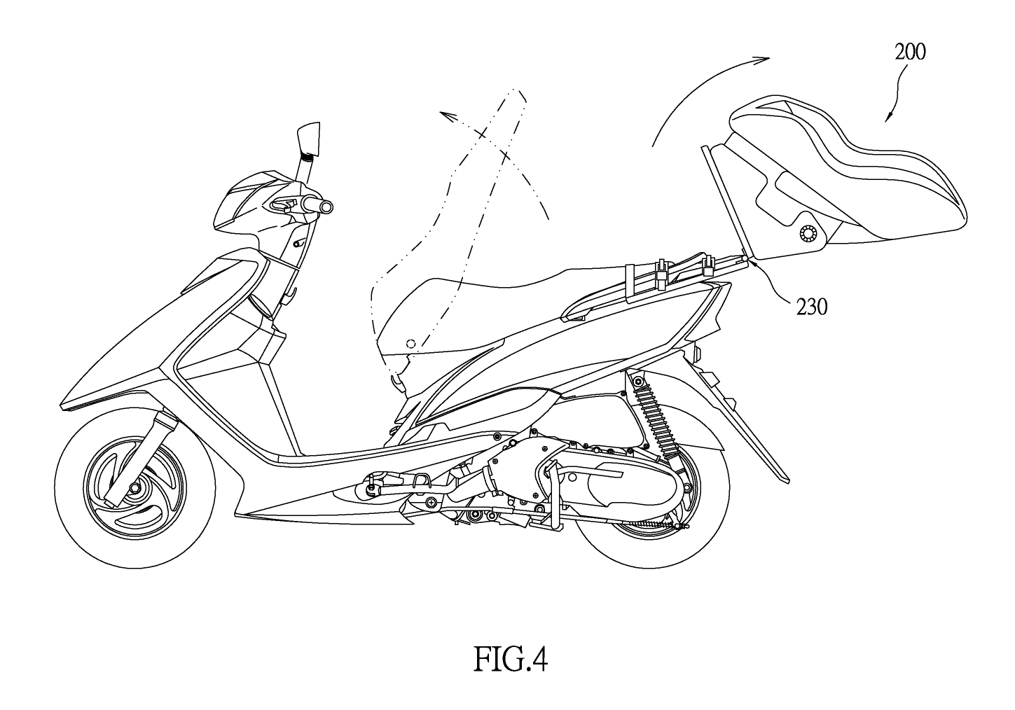

Please refer to FIG. 4, FIG. 4 shows a diagram when the motorcycle safety seat of FIG. 3 is raised. When the rider wants to take something from the vehicle compartment of the motorcycle, has to hoist the baby up and release the quick release mechanisms 240, then raise the seat body 110. Thus, the seat body 110 may be raised an angle toward to the rear of the motorcycle by pivotal portion 230, and the seat cushion further can be raised and do not block off by the seat body 110.

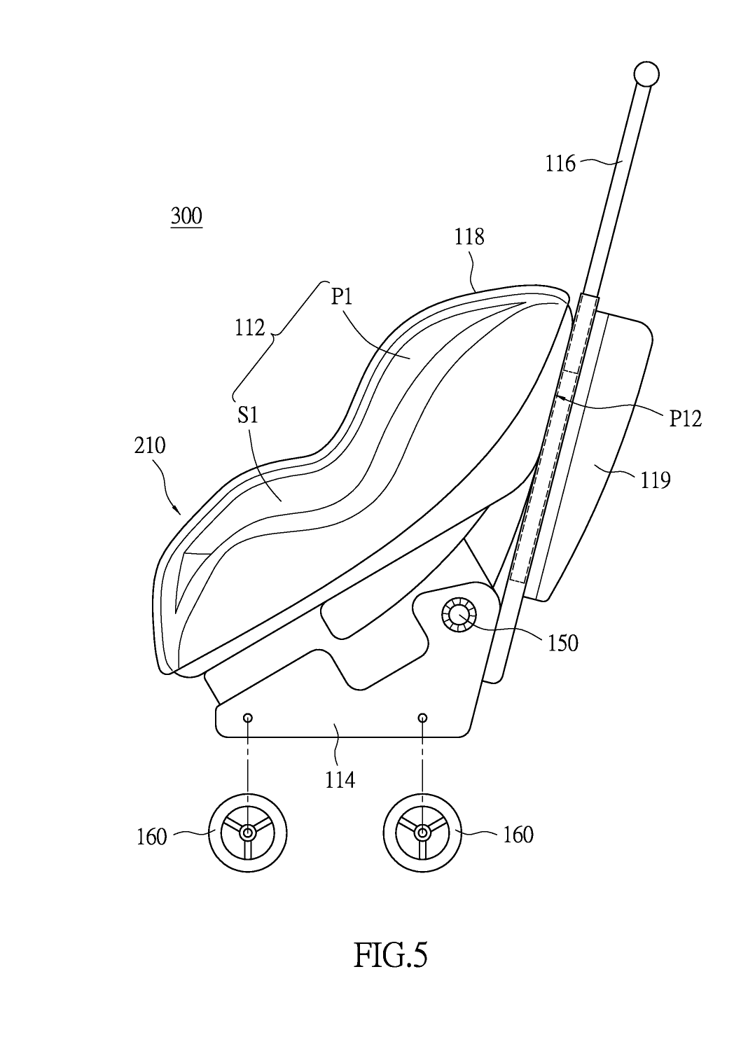

FIG. 5 shows a diagram of a motorcycle safety seat according to an embodiment of the present invention. A motorcycle safety seat 300 is similar to the motorcycle safety seat 200, such as the motorcycle safety seat 100 and 200 both have the seat body 110 and the fixing portion 120. It only illustrates the safety seat 210 as following, but other same features do not repeat here.

Please refer to FIG. 5, the safety seat 210 further includes a wheel assembly 160, and the wheel assembly 160 is configured for releasing the joint portion 114 of the safety seat 210. More specifically, the wheel assembly 160 includes at least one of axles and at least one of wheels. In other word, the wheel assembly 160 is a single-wheel assembly, double-wheel assemblys or three-wheel assembly. Wherein the wheel assembly 160 is disposed under the joint portion 114. When the rider releases the safety seat 210 from the motorcycle, may dispose the wheel assembly 160 under the under the joint portion 114. Thus, the safety seat 210 can be a baby car including the wheels. It's worth noting, the wheel assembly 160 may be a quick release wheel assembly and the rider can build the wheel assembly 160 up apace. However, the present disclosure isn't limited the design of the wheel assembly 160 thereto.

In addition, in the practice, the safety seat 210 further includes a retractable handle 116, and the retractable handle 116 is disposed on a seat reverse side P12 of the seat portion 112. Wherein the rider may move the safety seat 210 by the retractable handle 116. Furthermore, the retractable handle 116 is designed as one-part form, tow-part form, three-part form or multi-part form and easily stored into the safety seat 210. Moreover, a cavity is extra disposed on the seat reverse side P12 of the seat portion 112 and the retractable handle 116 may be outstretched from the cavity. Thus, the safety seat 210 can be a cart having the wheels and the rods.

The safety seat 210 further includes a cover cloth 118. The cover cloth 118 is configured for covering the seat portion 112, and protects the baby avoiding the effect liked the temperature or the weather variety. More specifically, the cover cloth 118 is connected with the safety seat 210. Generally, the cover cloth 118 connects with the top of the safety seat 210 and covers whole the seat cushion S1 of the seat portion 112, so as to cover the seat cushion S1 and the seat reverse side P1. It's worth noting, the cover cloth 118 can be connected with the top of the safety seat 210 by the Velcro or the slide. In addition, for protecting the baby more perfectly, the cover cloth 118 includes the functions of waterproof, wind reduction, ventilation or thermal insulation. The cover cloth 118 may be manufactured by the nylons net fabric, the cotton, or the combination of the each cotton material. Furthermore, the view window can be made on the nylons net fabric or the cotton by the transparent PVC fabric, so as to see the baby from the window. However, the present disclosure isn't limited the cover cloth 118 thereto.

In addition to this, the safety seat 210 further includes a storage bag 119 disposed on the seat reverse side P12 of the seat portion 112. The storage bag 119 is configured for storing the cover cloth 118 and storing the object of the rider. In generally, the rider can separate the storage bag 119 from the safety seat 210. In addition, the storage bag 119 is a drawstring bag, a pack, or a hand bag, and is connected with seat reverse side by the Velcro or the slide. However, the present disclosure isn't limited the storage bag 119 thereto.

As said above, it's worth noting, when the rider arrives a destination and wants to release the safety seat 210, disposes the wheel assembly 160 under the joint portion 114, and outstretches the retractable handle 116. Thus, the safety seat becomes a baby cart transporting the baby. In addition, when the rider wants to take something from the vehicle compartment of the motorcycle, has to hoist the baby up and release the quick release mechanisms 240, and then raise the seat body 110. Thus, the seat body 110 may be rotated around the pivotal portion 230 toward to the rear of the motorcycle by an angle, and the seat cushion further can be raised and do not block off by the seat body 110.

In sum up, the motorcycle safety seat in the embodiment of the present invention which includes the safety seat, the fixing portion and the pivotal portion. The fixing portion provides the fixity and the stability and fixes the motorcycle safety seat on the rear of the motorcycle. The pivotal portion is hinged between safety seat and the fixing portion, thus the safety seat may be rotated by an angle toward to the rear of the motorcycle by pivotal portion. Thus, the seat cushion further can be raised and do not block off by the safety seat.

In addition, the motorcycle safety seat in the embodiment of the present invention further includes the rod, the cover cloth and the wheel assembly which can be released quickly. Therefore, when the rider arrives a destination, releases the safety seat from the motorcycle. Furthermore, disposes the wheel assembly under the joint portion and outstretches the rod, then put down the cover cloth. Thus, the safety seat can be formed a baby cart.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A motorcycle safety seat disposed on a rear of a motorcycle, the motorcycle safety seat comprising:
a seat body comprising:
a seat portion; and
a joint portion disposed under the seat portion and connected with the seat portion;
a fixing portion disposed fixedly on the rear of the motorcycle; and
a pivotal portion hinged between the joint portion and the fixing portion;
wherein the safety seat detachably connects to the fixing portion by the joint portion, and the seat body is rotated relative to the rear around the pivotal portion.

2. The motorcycle safety seat according to claim 1, wherein the seat body is rotated around the pivotal portion in the direction from the rear of the motorcycle to a front of the motorcycle.

3. The motorcycle safety seat according to claim 1, further comprising a plurality of quick release mechanisms disposed between the joint portion and the fixing portion.

4. The motorcycle safety seat according to claim 3, wherein the quick release mechanisms are snap buckles, tenons or spring buckles.

5. The motorcycle safety seat according to claim 1, wherein the seat body further comprises a retractable handle disposed on a seat reverse side of the seat portion.

6. The motorcycle safety seat according to claim 1, further comprising a wheel assembly detachably connected detachably with the joint portion of the seat body.

7. The motorcycle safety seat according to claim 1, wherein the seat body further comprises a storage bag disposed on a seat reverse side of the seat portion, and the storage bag is configured for storing a cover cloth detachably connected to the safety seat.

8. The motorcycle safety seat according to claim 1, wherein the seat body further comprises an adjustable assembly configured for adjusting an oblique angle of the seat portion.

9. The motorcycle safety seat according to claim 1, wherein the pivotal portion is a whirling steel shaft assembly or a hinge.

10. The motorcycle safety seat according to claim 1, wherein the seat body further comprises a belt disposed on the seat portion.
